(19) United States
(12) Patent Application Publication
(10) Pub. No.: US 2015/0054397 A1
(43) Pub. Date: Feb. 26, 2015

(54) FIRE-RESISTANT OUTER CASING FOR ELECTRICAL INSTALLATION CABINETS IN RAIL VEHICLES

(71) Applicant: SIEMENS AKITENGESELLSCHAFT, MUENCHEN (DE)

(72) Inventor: Joachim Weiler, Wassenberg-Orsbeck (DE)

(21) Appl. No.: 14/386,432

(22) PCT Filed: Mar. 3, 2013
(86) PCT No.: PCT/EP2013/054349

§ 371 Date: Sep. 19, 2014

(30) Foreign Application Priority Data
Mar. 19, 2012 (DE) 102012204300.4

(51) Int. Cl. H02G 3/04; E05G 1/024; A47B 81/00; B61D 49/00

(52) U.S. Cl. CPC H02G 3/0412; B61D 49/00; E05G 1/024; A47B 81/00
USPC 312/409

(57) ABSTRACT

A fire-resistant outer casing for an electrical installation cabinet is particularly suited for use in a rail vehicle. The electrical installation cabinet has an installation space, an inner door and an outer casing. The outer casing is at least partially formed from veneered plywood. At least one layer of the veneered plywood is formed from a material which expands in the event of a fire.

The present invention relates to a fire-resistant outer casing for an electrical installation cabinet. In particular, the present invention relates to a fire-resistant outer casing for an electrical installation cabinet in a rail vehicle.

In modern rail vehicles, a large number of electrical or electronic control elements are fitted. These control elements also assume control tasks that are relevant to safety, and so the operational reliability of these control elements must be ensured in every situation. Even in the event of a fire within the rail vehicle, it must be ensured that the electrical or electronic control elements can perform the tasks intended for them in an operationally reliable manner.

Such control elements are usually grouped together in an electrical installation cabinet. A plurality of electrical installation cabinets may be arranged such that they are distributed throughout a rail vehicle or the interior compartment of a rail vehicle.

Due to the dissipation of heat from the fitted electronic or electrical control elements, a temperature of up to 70° C. occurs in the electrical installation cabinets. However, the fitted control elements are generally only operationally reliable up to a temperature of less than 85° C. If this limiting temperature is exceeded, multiple failure of the control elements must be expected. According to the requirements and specifications of the responsible supervisory authorities, even in the event of a fire operational reliability of the control elements must be ensured for at least 30 minutes.

To comply with these requirements, the installation cabinet may be made with correspondingly thick walls, the walls being of a flame-resistant and insulating design, and so the temperature requirements can even be met in the event of a fire. However, such a configuration of an electrical installation cabinet results in a high weight, which in turn results in an increase in the overall weight of the rail vehicle. The aim, however, is to keep the overall weight of the rail vehicle as low as possible, on the one hand in order to reduce the energy required for moving the rail vehicle, on the other hand in order to increase the payload.

In the case of rail vehicles that are to be used for passenger transportation, it is additionally desirable that the interior of the passenger compartment is of an attractive and pleasing design. For this purpose, it is popular for wood materials to be used for fittings in the rail vehicle. Thus, for example, it may be provided that wall panels or partitions are at least partially made of wood.

Electrical installation cabinets are often to be found at the head or end region of the rail vehicle, a region that in certain types of rail vehicle is usually provided with wood casings. The electrical installation cabinets are located behind these wood casings.

However, the provision of wood casings introduces further fire loads into the rail vehicle that in the event of an accident can catch fire.

It is therefore the object of the present invention to provide an electrical installation cabinet that has an interior-compatible appearance with an acceptable overall weight.

This object is achieved by an electrical installation cabinet as claimed in claim 1. Consequently, an electrical installation cabinet for receiving electrical and/or electronic control elements is proposed, having an installation space, an inner door and an outer casing, which cabinet is characterized in that the outer casing is at least partially formed from a veneered plywood, wherein at least one layer of the veneered plywood is formed from a material which expands in the event of a fire.

It is consequently proposed to encase the electrical installation cabinet, for example with respect to the passenger compartment, by a veneered plywood panel or multiplex panel, which comprises a layer of a material that is fire-retardant and has an insulating effect in the event of a fire. The material which expands or foams in the event of a fire has the effect of forming an insulating layer with respect to the heat exposure caused by a fire, which can prevent the temperature from rising inside the electrical installation cabinet, at least for the intended time of 30 minutes. The use of a corresponding veneered plywood or corresponding multiplex panel makes it possible to dispense with an additional insulating fire-resistant configuration of the electrical installation cabinet. At the same time, the veneered plywood offers a pleasing outer appearance that is compatible with the interior design. In addition, the configuration according to the invention of an electrical installation cabinet allows a weight saving to be achieved, which results in a further reduction in the overall weight of the rail vehicle.

According to one configuration of the electrical installation cabinet according to the invention, the material which expands in the event of a fire is an alkali silicate. The alkali silicate is preferably a water-containing sodium silicate. In addition, the ii material may comprise organic additives, glass fibers, glass fabric or else a wire mesh to increase the mechanical stability.

Thermal exposure above a temperature of 100° C. causes the material to blister and foam. This creates a thermally insulating foam layer that can withstand temperatures of up to 600° C.

According to a further configuration of the electrical installation cabinet according to the invention, the layer comprising the material which expands in the event of a fire has a thickness of between 1.0 mm and 5.0 mm. It has been found that such a thin layer is sufficient to ensure sufficient thermal insulation of the elements fitted inside the electrical installation cabinet in the event of a fire, and so the functional reliability of the elements is ensured for a sufficient period of time.

In a further configuration of the electrical installation cabinet according to the invention, the veneered plywood comprises at least two layers that are formed from a material which expands in the event of a fire. This makes it possible to increase the thermal insulation further.

In a further configuration of the electrical installation cabinet according to the invention, the installation space and the inner door are produced from a metal, such as for example a steel sheet and/or an aluminum sheet. Steel sheet and/or aluminum sheet can be understood here as also meaning sheets of steel and/or aluminum alloys.

In a preferred configuration of the invention, the outer casing is formed in the region of the inner door as a door element. This allows the outer casing to be opened in an easy way and thus provide access to the electrical installation cabinet.

In a further preferred configuration of the invention, the inner door and the region of the outer casing formed as a door element are hung on opposite sides. Hung on opposite sides means here for example that the door element of the outer casing can be opened to the right, while the inner door is opened to the left. As a result, easy accessibility to the electrical and/or electronic elements fitted in the installation space of the electrical installation cabinet is possible.

According to a further configuration of the electrical installation cabinet according to the invention, the inner door and the region of the outer casing formed as a door element can be opened in the same direction.

In a further preferred configuration of the electrical installation cabinet according to the invention, the outer casing comprises an HPL layer as the outer layer. An HPL layer (High-Pressure Laminate) is understood as meaning materials in which fibrous substances such as for example wood, paper, paperboard or textile fibers are impregnated in melamine or phenolic resin and pressed together under pressure and heat to form a panel. By using heat-resistant resins, surfaces that are easy to care for and can be cleaned well are thereby obtained. In addition, such layers are light-resistant, odor-neutral and substantially insensitive to liquids, such as for example water, alcohol or organic solvents.

In addition, the present invention relates to the use of a veneered plywood, comprising at least one layer of a material which expands in the event of a fire, as the outer casing, directed toward the passenger compartment, for an electrical installation cabinet in a rail vehicle.

The invention is explained in more detail below on the basis of figures.

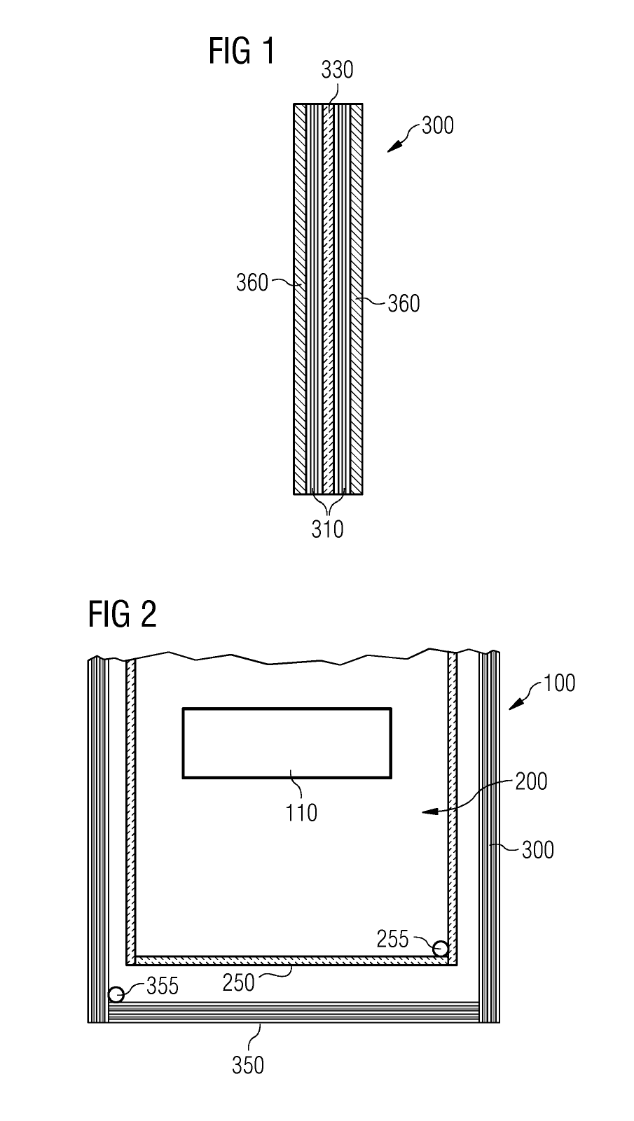

FIG. 1 schematically shows the structure of a configuration of an outer casing to be used according to the invention;

FIG. 2 schematically shows the construction of a configuration of an electrical installation cabinet according to the invention.

FIG. 1 schematically shows the construction of a configuration of an outer casing 300 used according to the invention. The outer casing 300 consists of a veneered plywood 310, which comprises at least one layer 330 of a material which expands in the event of a fire. The visible surfaces of the outer casing 300 may be additionally covered by an HPL layer 360, in order to make the outer casing easy to care for and resistant. In the event of a fire, the temperature to which the outer casing 300 is exposed by the fire leads to an expansion of the material in the layer 300. This has the effect of forcing apart the veneered plywood and creating a thermal insulating layer, which can prevent a further temperature increase on the side of the outer casing that is facing away from the source of the fire, to the greatest extent at least for a sufficient period of time.

FIG. 2 shows the schematic construction of a configuration of an electrical installation cabinet 100 according to the invention. The electrical installation cabinet 100 has an installation space 200, in which control elements 110 are fitted. The electrical installation cabinet 100 is in this case formed for example as a steel casing. Accessibility to the control elements 110 is made possible by way of the inner door 250 of the electrical installation cabinet 100. With respect to the passenger compartment, the electrical installation cabinet 100 is encased by an outer casing 300. The outer casing 300 is at least partially formed from a veneered plywood, wherein at least one layer of the veneered plywood is formed from a material which expands in the event of a fire. In the region of the inner door 250, the outer casing is formed as a door element 350, and so removal of the outer casing to gain access to the inner door 250 is easily possible. In the embodiment shown, the inner door 250 and the door element 350 are hung on opposite sides 255, 355.

1-10. (canceled)

11. An electrical installation cabinet for housing electrical and/or electronic control elements, the installation cabinet comprising:
an outer casing, an installation space, and an inner door;
said outer casing being formed, at least partially, of a veneered plywood and said veneered plywood having at least one layer formed of a material that expands in the event of a fire.

12. The electrical installation cabinet according to claim 11, wherein said material which expands in the event of a fire comprises an alkali silicate.

13. The electrical installation cabinet according to claim 11, wherein said at least one layer with said material which expands in the event of a fire has a thickness of between 1.0 mm and 5.0 mm.

14. The electrical installation cabinet according to claim 11, wherein said veneered plywood comprises at least two layers that are formed of a material that expands in the event of a fire.

15. The electrical installation cabinet according to claim 11, wherein said installation space and said inner door are formed of a metal.

16. The electrical installation cabinet according to claim 15, wherein said metal is selected from the group consisting of a steel sheet and an aluminum sheet.

17. The electrical installation cabinet according to claim 11, wherein said outer casing, in a vicinity of said inner door, is formed as a door element.

18. The electrical installation cabinet according to claim 17, wherein said inner door and said door element are hung in mutually opposite orientations.

19. The electrical installation cabinet according to claim 17, wherein said inner door and said door element are configured for opening in the same direction.

20. The electrical installation cabinet according to claim 11, wherein said outer casing comprises a high-pressure laminate layer forming an outer layer thereof.

21. The electrical installation cabinet according to claim 11 in combination with a rail vehicle, wherein said outer casing is disposed with said veneered plywood having said at least one layer formed of the material that expands in the event of a fire facing toward a passenger compartment of the rail vehicle.

22. In combination with a rail vehicle having a passenger compartment, a veneered plywood, comprising at least one layer of a material that expands in the event of a fire, said veneered plywood forming an outer casing of an electrical installation cabinet and said outer casing it directed toward the passenger compartment of the rail vehicle.
